(19) United States
(12) Patent Application Publication
(10) Pub. No.: US 2020/0019370 A1
(43) Pub. Date: Jan. 16, 2020

(54) COLLABORATIVE AI STORYTELLING

(71) Applicant: Disney Enterprises, Inc., Burbank, CA (US)

(72) Inventors: Erika Varis Doggett, Burbank, CA (US); Edward Drake, Burbank, CA (US); Benjamin Havey, Burbank, CA (US)

(73) Assignee: Disney Enterprises, Inc., Burbank, CA (US)

(21) Appl. No.: 16/034,310

(22) Filed: Jul. 12, 2018

(51) Int. Cl. G06F 3/16; G06F 17/27; G10L 15/22; G10L 15/18; G10L 13/04; G06F 17/30; G06N 3/00

(52) U.S. Cl. CPC G06F 3/16; G06F 17/277; G06F 17/2705; G10L 15/22; G06N 3/006; G10L 15/1815; G10L 13/043; G06F 17/3053; G10L 15/1822

(57) ABSTRACT

Implementations of the disclosure describe AI systems that offer an improvisational story telling AI agent that may interact collaboratively with a user. In one implementation, a story telling device may be implemented using i) a natural language understanding (NLU) component to process human language input (e.g., digitized speech or text input); ii) a natural language processing (NLP) component to parse the human language input into a story segment or sequence; iii) a component for storing/recording the story as it is created by collaboration; iv) a component for generating AI-suggested story elements; and v) a natural language generation (NLG) component to transform the AI-generated story segment into natural language that may be presented to the user.

### BRIEF SUMMARY OF THE DISCLOSURE

Implementations of the disclosure are directed to artificial intelligence (AI) systems that offer an improvisational story telling AI agent that may interact collaboratively with a user.

In one example, a method includes: receiving, from a user, human language input corresponding to a segment of a story; understanding and parsing the received human language input to identify a first story segment corresponding to a story associated with a stored story record; updating the stored story record using at least the identified first story segment corresponding to the story; using at least the identified first story segment or updated story record, generating a second story segment; transforming the second story segment into natural language to be presented to the user; and presenting the natural language to the user. In implementations, receiving the human language input includes: receiving vocal input at a microphone and digitizing the received vocal input; and where presenting the natural language to the user includes: transforming the natural language from text to speech; and playing back the speech using at least a speaker.

In implementations, understanding and parsing the received human language input includes parsing the received human language input into one or more token segments, the one or more token segments corresponding to a character, setting, or plot of the story record. In implementations, generating the second story segment includes: performing a search for a story segment within a database comprising a plurality of annotated story segments; scoring each of the plurality of annotated story segments searched in the database; and selecting the highest scored story segment as the second story segment.

In implementations, generating the second story segment includes: implementing a sequence-to-sequence style language dialogue generation model that has been pre-trained on narratives of a desired type to construct the second story segment, given the updated story record as an input.

In implementations, generating the second story segment includes: using a classification tree to classify whether the second story segment corresponds to a plot narrative, a character expansion, or setting expansion; and based on the classification, using a plot generator, a character generator, or setting generator to generate the second story segment.

In implementations, the generated second story segment is a suggested story segment, the method further including: temporarily storing the suggested story segment; determining if the user confirmed the suggested story segment; and if the user confirmed the suggested story segment, updating the stored story record with the suggested story segment.

In implementations, the method further includes: if the user does not confirm the suggested story segment, removing the suggested story segment from the story record.

In implementations, the method further includes: detecting an environmental condition, the detected environmental condition including: a temperature, a time of day, a time of year, a date, a weather condition, or a location, where the generated second story segment incorporates the detected environmental condition.

In implementations, the method further includes: displaying an augmented reality or virtual reality object corresponding to the natural language. In particular implementations, the display of the augmented reality or virtual reality object is based at least in part on the detected environmental condition.

In implementations, the aforementioned method may be implemented by a processor executing machine readable instructions stored on a non-transitory computer-readable medium. For example, the aforementioned method may be implemented in a system including a speaker, a microphone, the processor and the non-transitory computer-readable medium. Such a system may comprise a smart speaker, mobile device, head mounted display, gaming console, or television.

As used herein, the term “augmented reality” or “AR” generally refers to a view of a physical, real-world environment that is augmented or supplemented by computer-generated or digital information such as video, sound, and graphics. The digital information is directly registered in the user's physical, real-world environment such that the user may interact with the digital information in real time. The digital information may take the form of images, audio, haptic feedback, video, text, etc. For example, three-dimensional representations of digital objects may be overlaid over the user's view of the real-world environment in real time.

As used herein, the term “virtual reality” or “VR” generally refers to a simulation of a user's presence in an environment, real or imaginary, such that the user may interact with it.

Other features and aspects of the disclosed method will become apparent from the following detailed description, taken in conjunction with the accompanying drawings, which illustrate, by way of example, the features in accordance with embodiments of the disclosure. The summary is not intended to limit the scope of the claimed disclosure, which is defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments of the disclosure.

FIG. 1A illustrates an example environment, including a user interacting with a storytelling device, in which collaborative AI storytelling may be implemented in accordance with the disclosure.

FIG. 1B is a block diagram illustrating an example architecture of components of the storytelling device of FIG. 1A.

FIG. 2 illustrates example components of story generation software in accordance with implementations.

FIG. 3 illustrates an example beam search-and-rank algorithm that may be implemented by a story generator component, in accordance with implementations.

FIG. 4 illustrates an example implementation of character context transformation that may be implemented by a character context transformer, in accordance with implementations.

FIG. 5 illustrates an example story generator sequence-to-sequence model, in accordance with implementations.

FIG. 6 is an operational flow diagram illustrating an example method of implementing collaborative AI storytelling, in accordance with the disclosure.

FIG. 7 is an operational flow diagram illustrating an example method of implementing collaborative AI storytelling with a confirmation loop, in accordance with the disclosure.

FIG. 8 illustrates a story generator component comprised of a multipart system including: i) a classifier or decision component to decide whether the “next suggested segment” should be plot narrative, character expansion, or setting expansion; and ii) a generation system for each one of those segment types.

FIG. 9 illustrates an example computing component that may be used to implement various features of the methods disclosed herein.

The figures are not exhaustive and do not limit the disclosure to the precise form disclosed.

### DETAILED DESCRIPTION

As new mediums such as VR and AR become available to storytellers, the opportunity to incorporate automated interactivity in storytelling opens up beyond the medium of a live, human performer. Currently, collaborative and performative storytelling takes the form of multiple human actors or agents improvising, such as a comedy improvisation sketch group, or even children playing pretend together.

Present implementations of electronic-based storytelling allow little to no improvisation in the story that is presented to a user. Although some present systems may permit a user to traverse one of multiple branching plots depending on choices made by the user (e.g., in the case of video games having multiple endings), the various plotlines that are available to be traversed and the choices that are made available to the user are all predetermined. As such, there is a need for systems that may offer greater story-telling improvisation, including playing the part of one or more of the human agents in a storytelling venue, to create a story on the fly, in real-time.

To this end, the disclosure is directed to artificial intelligence (AI) systems that offer an improvisational story telling AI agent that may interact collaboratively with a user. By way of example, an improvisational storytelling AI agent may be implemented as an AR character that plays pretend with a child and creates a story with them, without needing to find other human playmates to participate. As another example, an improvisational storytelling agent may be implemented as a one-man improvisation performance, with the system providing the additional input to act out improvisation scenes.

By virtue of implementing an AI system offering an improvisational story telling AI agent, a new mode of creative storytelling that provides the advantages of machine over human may be achieved. For example, for children without siblings, the machine may provide a collaborative storytelling outlet that might not otherwise be available to the child. For screenwriters, the machine may provide a writing assistant that does not require its own human sleep/work schedule to be arranged around.

In accordance with implementations further described below, an improvisational storytelling device may be implemented using i) a natural language understanding (NLU) component to process human language input (e.g., digitized speech or text input); ii) a natural language processing (NLP) component to parse the human language input into a story segment or sequence; iii) a component for storing/recording the story as it is created by collaboration; iv) a component for generating AI-suggested story elements; and v) a natural language generation (NLG) component to transform the AI-generated story segment into natural language that may be presented to the user. In implementations involving vocal interaction between the user and storytelling device, the device may additionally implement a speech synthesis component for transforming the textual natural language generated by the NLG component into auditory speech.

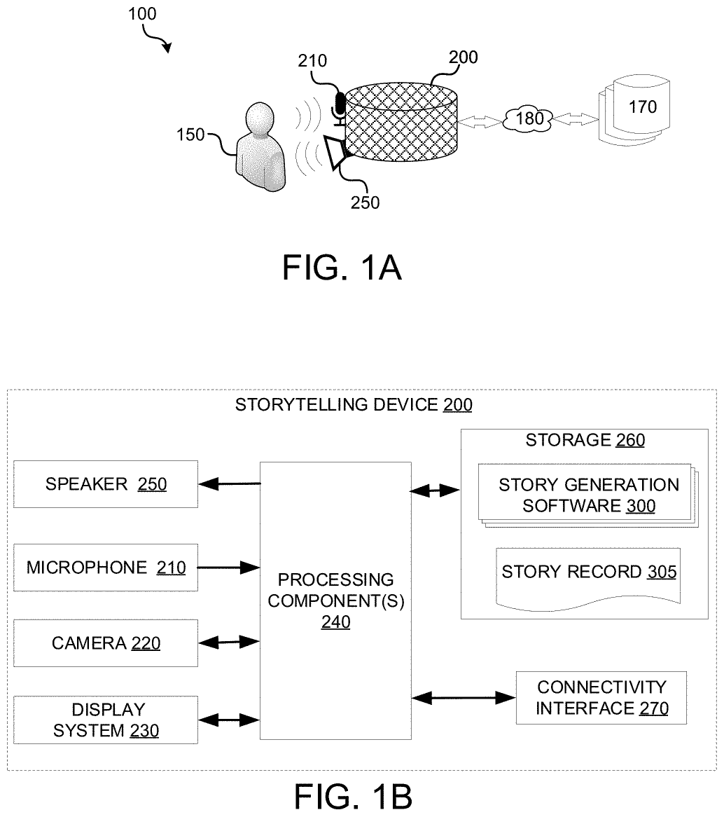

FIG. 1A illustrates an example environment 100, including a user 150 interacting with a storytelling device 200, in which collaborative AI storytelling may be implemented in accordance with the disclosure. FIG. 1B is a block diagram illustrating an example architecture of components of a storytelling device 200. In example environment 100, user 150 vocally interacts with storytelling device 200 to collaboratively generate a story. Device 200 may function as an improvisational storytelling agent. Responsive to vocal user input relating to a story that is received through microphone 210, device 200 may process the vocal input using story generation software 300 (further discussed below) and output a next sequence or segment in the story using speaker 250.

In the illustrated example, storytelling device 200 is a smart speaker that auditorily interacts with user 150. For example, story generation software 300 may be implemented using an AMAZON ECHO speaker, a GOOGLE HOME speaker, a HOMEPOD speaker, or some other smart speaker that stores and/or executes story generation software 300. However, it should be appreciated that storytelling device 200 need not be implemented as a smart speaker. Additionally, it should be appreciated that interaction between user 150 and device 200 need not be limited to conversational speech. For example, user input may take the form of speech, text (e.g., as captured by a keypad or touchscreen), and/or sign language (e.g., as captured by a camera 220 of device 200). Additionally, output by device 200 may take the form of machine-generated speech, text (e.g., as displayed by a display system 230), and/or sign language (e.g., as displayed by a display system 230).

For example, in some implementations storytelling device 200 may be implemented as a mobile device such as a smartphone, tablet, laptop, smartwatch, etc. As another example, storytelling device 200 may be implemented as a VR or AR head mounted display (HMD) system, tethered or untethered, including a HMD that is worn by the user 150. In such implementations, the VR or AR HMD, in addition to providing speech and/or text corresponding to a collaborative story, may render a VR or AR environment that corresponds to the story. The HMD may be implemented in a variety of form factors such as, for example, a headset, goggles, a visor, or glasses. Further examples of a storytelling device that may be implemented in some embodiments include a smart television, a video game console, a desktop computer, a local server, or a remote server.

As illustrated by FIG. 1B, storytelling device 200 may include a microphone 210, a camera 220, a display system 230, processing component(s) 240, speaker 250, storage 260, and connectivity interface 270.

During operation, microphone 210 receives vocal input (e.g., vocal input corresponding to a storytelling collaboration) from a user 150 that is digitized and made available to story generation software 300. In various embodiments, microphone 210 may be any transducer or plurality of transducers that converts sound into an electric signal that is later converted to digital form. For example, microphone 210 may be a digital microphone including an amplifier and analog to digital converter. Alternatively, a processing component 160 may digitize the electrical signals generated by microphone 210. In some cases (e.g., in the case of smart speaker), microphone 210 may be implemented as an array of microphones.

Camera 220 may capture a video of the environment from the point of view of device 200. In some implementations, the captured video may be used to capture video of a user 150 that is processed to provide inputs (e.g., sign language) for a collaborative AI storytelling experience. In some implementations, the captured video may be used to augment the collaborative AI storytelling experience. For example, in implementations where storytelling device 200 is a HMD, an AR object representing an AI storytelling agent or character may be rendered and overlaid over video captured by camera 220. In such implementations, device 200 may also include a motion sensor (e.g., gyroscope, accelerometer, etc.) that may track the position of a HMD worn by a user 150 (e.g., absolute orientation of HMD in the north-east-south-west (NESW) and up-down planes).

Display system 230 may be used to display information and/or graphics related to the collaborative AI storytelling experience. For example, display system 230 may display text (e.g., on a screen of a mobile device) generated by a NLG component of story generation software 300, further described below. Additionally, display system 230 may display an AI character and/or a VR/AR environment presented to the user 150 during the collaborative AI storytelling experience.

Speaker 250 may be used to output audio corresponding to machine-generated language as part of an audio conversation. During audio playback, processed audio data may be converted to an electrical signal that is delivered to a driver of speaker 250. The speaker driver may then convert the electric into sound for playback to the user 150.

Storage 260 may comprise volatile memory (e.g. RAM), non-volatile memory (e.g. flash storage), or some combination thereof. In various embodiments, storage 260 stores story generation software 300, that when executed by a processing component 240 (e.g., a digital signal processor), causes device 200 to perform collaborative AI storytelling functions such as collaboratively generating a story with a user 150, storing a record 305 of the generated story, and causing speaker 250 to output generated story languages in natural language. In implementations where story generation software 300 is used in an AR/VR environment where device 200 is a HMD, execution of story generation software 300 may also cause the HMD to display AR/VR visual elements corresponding to a storytelling experience.

In the illustrated architecture, story generation software 300 may be locally executed to perform processing tasks related to providing a collaborative storytelling experience between a user 150 and a device 200. For example, as further described below, story generation software 300 may perform tasks related to NLU, NLP, story storage, story generation, and NLG. In some implementations, some or all of these tasks may be offloaded to a local or remote server system for processing. For example, story generation software 300 may receive digitized user speech as an input that is transmitted to a server system. In response, the server system may generate and transmit back NLG speech to be output by a speaker 260 of device 200. As such, it should be appreciated that, depending on the implementation, story generation software 300 may be implemented as a native software application, a cloud-based software application, a web-based software application, or some combination thereof.

Connectivity interface 270 may connect storytelling device 200 to one or more databases 170, web servers, file servers, or other entity over communication medium 180 to perform functions implemented by story generation software 300. For example, one or more application programming interfaces (APIs) (e.g., NLU, NLP, or NLG APIs), a database of annotated stories, or other code or data may be accessed over communication medium 180. Connectivity interface 270 may comprise a wired interface (e.g., ETHERNET interface, USB interface, THUNDERBOLT interface, etc.) and/or a wireless interface such as a cellular transceiver, a WIFI transceiver, or some other wireless interface for connecting storytelling device 200 over a communication medium 180.

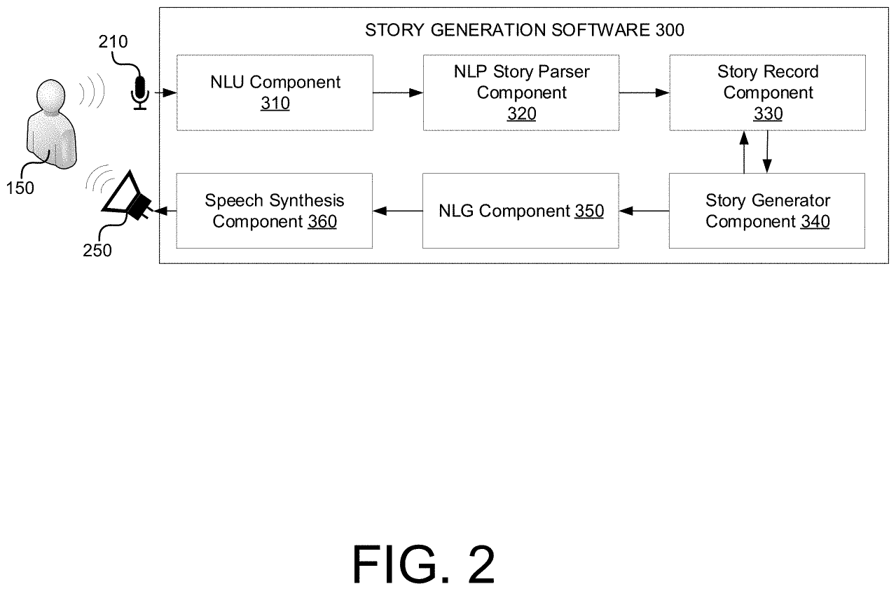

FIG. 2 illustrates example components of story generation software 300 in accordance with embodiments. Software generation software 300 may receive as input digitized user input (e.g., textual, speech, etc.) corresponding to a story segment and output another segment of the story for presentation to the user (e.g., playback on a display and/or speaker). For example, as illustrated by FIG. 2, after microphone 210 receives vocal input from user 150, the digitized vocal input may be processed by story generation software 300 to generate a story segment that is played back to the user 150 by speaker 250.

As illustrated, story generation software 300 may include a NLU component 310, a NLP story parser component 320, a story record 330, a story generator component 340, a NLG component 350, and a speech synthesis component 360. One or more components 310-360 may be integrated into a single component and story generation software 300 may be a subcomponent of another software package. For example, story generation software 300 may be integrated into a software package corresponding to a voice assistant.

NLU component 310 may be configured to process the digitized user input (e.g., in the form of sentences in text or speech format) to understand the input (i.e., human language) for further processing. It may extract the portion of the user input that needs to be translated in order for NLP story parser component 320 to perform parsing of story elements or segments. In implementations where the user input is speech, NLU component 310 may also be configured to convert digitized speech input (e.g., a digital audio file) into text (e.g., a digital text file). In such implementations, a suitable speech API such as a GOOGLE speech to text API or AMAZON speech to text API may be used. In some implementations, a local speech-to-text/NLU model may be run without using an internet connection, which may increase security and allow the user to have full control over their private language data.

NLP story parser component 320 may be configured to parse the human natural language input into a story segment. The human natural language input may be parsed into suitable or appropriate word or token segments to identify/classify keywords such as character names and/or actions corresponding to a story, and to extract additional language information such as part-of-speech category, syntactic relational category, content versus function word identification, conversion into semantic vectors, among others. In some implementations, parsing may include removing certain words (e.g., stop words that carry little importance) or punctuation (e.g., periods, commas, etc.) to arrive at a suitable token segment. Such a process may include performing lemmatization, stemming, etc. During parsing, semantic parsing NLP systems such as the Stanford NLP, the Apache OpenNLP, or the Clear NLP may be used to identify entity names (e.g., character names) and performing functions such as generating entity and/or syntactic relation tags.

For example, consider a storytelling AI associated with the name “Tom.” If the human says, “Let's play Cops and Robbers. You be the cop, and Mr. Robert will be the robber,” NLP story parser component 320 may represent the story segment as “Title: Cops and Robbers. Tom is the cop. Mr. Robert is the robber.” During initial configuration of a story, NLP story parser component 320 may save character logic for future interactive language adjustment, such that the initial setup sequence of “You be the cop, and Mr. Robert will be the robber” translates to a character entity logic of “you→self→Tom” and “Mr. Robert→3rd person singular.” This entity logic may be forwarded to story generator component 340.

Story record component 330 may be configured to document or record the story as it is progressively created by collaboration. For example, a story record 305 may be stored in a storage 260 as it is written. In some implementations, story record component 330 may be implemented as a state-based chat dialogue system, and a story segment record could be implemented as a gradually written state machine.

Continuing the previous example, a story record may be written as follows:

1. Tom is the cop. Mr. Robert is the robber.

2. Tom is at the Sheriff station.

3. The grocer's son runs in to tell Tom there's a bank robbery.

4. Tom races out.

5. Tom gets on Roach the horse.

6 . . .

Story generator component 340 may be configured to generate AI-suggested story segments. The generated suggestion may be for continuing the story, whether that involves writing a narrative or plot point, or expanding upon character, settings, etc. During operation, there may be full cross-reference between story record component 330 and story generator component 340 to allow referencing of characters and previous story steps.

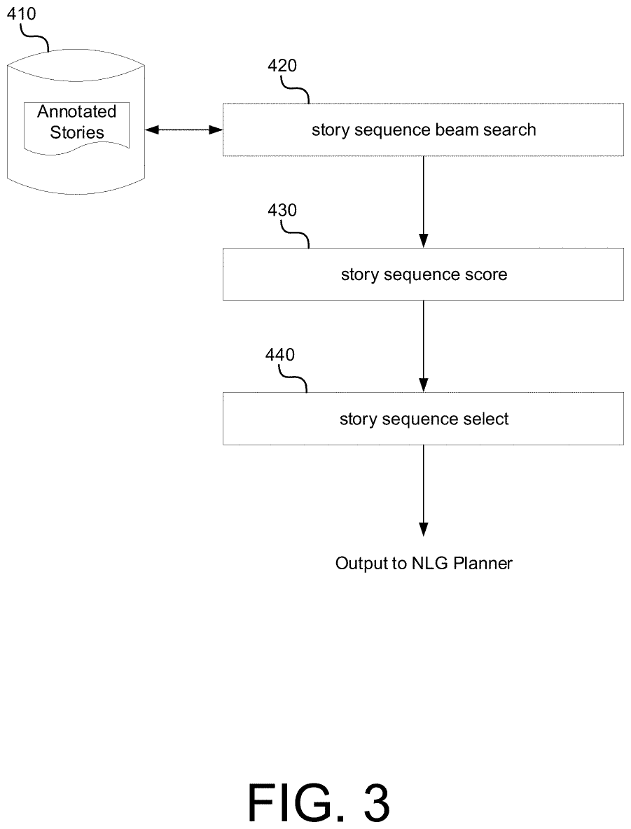

In one implementation, illustrated by FIG. 3, story generator component 340 may implement a beam search-and-rank algorithm that searches within a database 410 of annotated stories to determine a next best story sequence. In particular, story generator component 340 may implement a process of performing a story sequence beam search within a database 410 (operation 420), scoring the searched story sequences (operation 430), and selecting a story sequence from the scored story sequences (operation 440). For example, the story sequence having the highest score may be returned. In such an implementation, NLG component 350 may include a NLG sentence planner composed of a surface realization component combined with a character context transformer that may utilize the aforementioned character logic to modify the generated story text to be appropriate for a first person collaborator perspective.

The surface realization component may be to produce a sequence of words or sounds given an underlying meaning. For example, the meaning for [casual greeting] may have multiple surface realizations, e.g., “Hello”, “Hi”, “Hey” etc. A context free grammar (CFG) component is one example of a surface realization component that may be used in implementations.

Continuing the example of above, given a highest scoring proposed story segment composed of “[[character]₁ [transportation] [transport character]₂”, the surface realization component may use the initial character and genre settings to identify [character]₁→sheriff→Tom→sentence subject; [transportation]→{Old West}→by horse→verb; [transport character]₂→horse's name→[name generator]→Roach, and to additionally provide the sentence ordering for those elements in natural language, e.g., “Tom rides Roach the horse.” In implementations, the beam search and rank process may be performed in accordance with Neil McIntyre and Mirella Lapata, Learning to Tell Tales: A Data-driven Approach to Story Generation, August 2009, which is incorporated herein by reference.

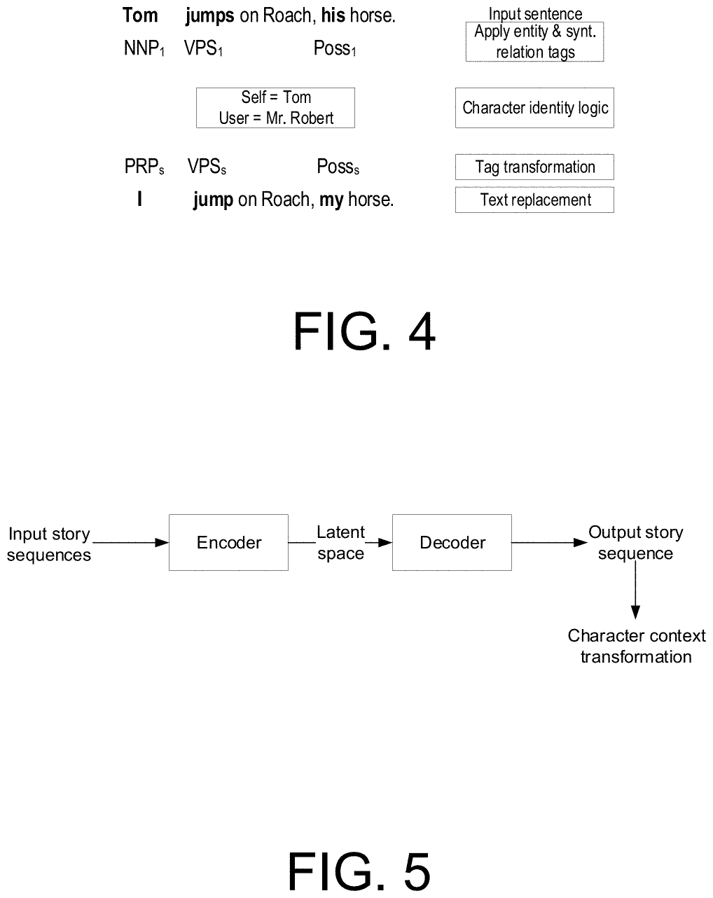

FIG. 4 illustrates an example implementation of character context transformation that may be implemented by a character context transformer. The character context transformer may better enable an AI character to act “in character” and use the appropriate pronouns (for itself and/or the collaborating user) instead of only speaking in third person. Character context transformation may be applied after story parsing, after AI story segment proposal, and before a story segment is presented to a user. The character context transformation may be achieved by applying entity and syntactic relation tags to an input sentence, and relating those to the established character logic, to then change the tags in accordance with character logic, and then transform the individual words of the sentence. For instance, continuing the previous example, for an input sentence such as “Tom jumps on Roach, his horse,” the application of entity and syntactic relation tags may result in the word “Tom” being identified as a proper name noun phrase with the entity marker 1. The word “jumps” may be identified as a verb phrase in the present tense 3rd person singular with the syntactic agreement relation to the entity 1, since entity 1 is the subject of the verb. The word “his” may be identified as a 3rd person masculine possessive pronoun referring to the entity 1.

In this example, as the saved character logic may dictate that the AI self is the same entity as Tom, which has been marked as entity 1, all tags marked for entity 1 may be transformed to be marked for “self”. The adjusted self-transformed tags may result in “I” for the pronoun Noun Phrase equivalent of “Tom”, “jump” as the verb phrase 1st person singular equivalent for “jumps”, and “my” as the first person possessive pronoun for “his.” Text replacement may be applied according to the new tags, resulting in a new sentence that tells the story sequence from the first person perspective of the AI storytelling collaborator.

In another implementation, story generator component 340 may implement a sequence-to-sequence style language dialogue generation system that has been pre-trained on narratives of the desired type, and may construct the next suggested story segment, given all previous story sequences in a story record 305 as input. FIG. 5 illustrates an example story generator sequence-to-sequence model. As shown in the example of FIG. 5, the input to such a neural network sequence-to-sequence architecture would be the collection of previous story segments. In an encoding step, an encoder model would transform the segments from text into a numeric vector representation within the latent space, a matrix representation of possible dialogue. The numeric vector would then pass to the decoder model, which produces the natural language text output for the next story sequence. This neural network architecture has been used in NLP research for chat dialogue generation as well as machine translation and other use cases, with a variety of implementations on the overall modeling architecture (for example, including Long Short Term Memory networks with Attention and memory gating mechanisms). It should be appreciated that many variations are available for this model architecture. In this implementation, the resulting story sequence may not need to go through a surface realization component, but may still be routed to character context transformation.

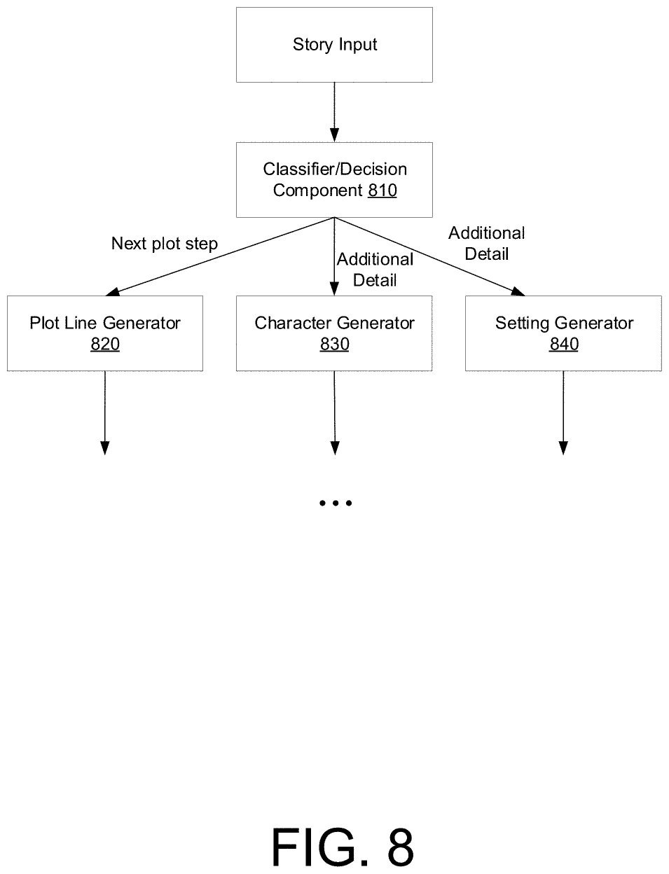

In another implementation, illustrated by FIG. 8, story generator component 340 may comprise a multipart system including: i) a classifier or decision component 810 to decide whether the “next suggested segment” should be plot narrative, character expansion, or setting expansion; and ii) a generation system for each one of those segment types, i.e., plot line generator 820, character generator 830, and setting generator 840. The generation system for each of those segment types may be a generative neural network NLG model, or it may be composed of databases of segment snippets to choose from. If the latter, for example, a “character expansion” component may have a number of different character archetypes listed, such as “young ingenue,” “hardened veteran,” “wise older advisor,” along with different character traits, such as “cheerful,” “grumpy,” “determined,” etc. The component may then choose probabilistically which archetype or trait to suggest, depending on other story factors as input (e.g., If the story has previously recorded a character as “cheerful” then the character expansion component may be more likely to choose semantically similar details, rather than next suggest that this same character be “grumpy.”) The output of the plot line generator 820, character generator 830, or setting generator 840 may then be transformed into a usable story record, e.g. by using a suitable NLP parser.

NLG component 350 may be configured to transform the AI generated story segment into natural language to be presented to a user 150 as discussed above. For example, NLG component 350 may receive a suggested story segment from story generator component 340 that is expressed in a logical form and may convert the logical expression into an equivalent natural language expression, such as an English sentence that communicates substantially the same information. NLG component 350 may include an NLP parser to provide a transformation from a base plot/character/setting generator into a natural language output.

In implementations where a device 200 outputs machine-generated natural language using a speaker 250, speech synthesis component 360 may be configured to transform the machine-generated natural language (e.g., output of component 350) into auditory speech. For example, the result of an NLG sentence planner & character context transformation may be sent to speech synthesis component, which may convert or match a text file containing generated natural language expressions to a corresponding audio file to then be spoken out to the user from the speaker 250.

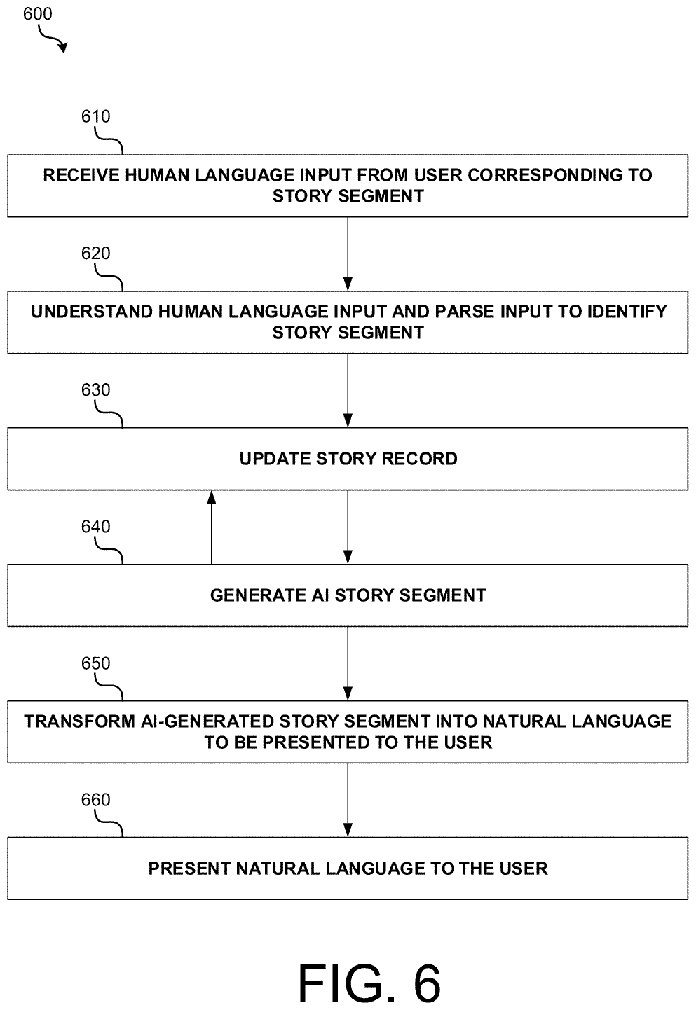

FIG. 6 is an operational flow diagram illustrating an example method 600 of implementing collaborative AI storytelling in accordance with the disclosure. In implementations, method 600 may be performed by executing story generation software 300 or other machine readable instructions stored in a device 200. Although method 600 illustrates an iteration of a collaborative AI storytelling process, it should be appreciated that method 600 may be iteratively repeated to build a story record and continue the storytelling process.

At operation 610, human language input corresponding to a segment of a story may be received from a user. The received human language input may be received as verbal input (e.g., speech), text-based input, or sign-language based input. If the received human language input comprises speech, the speech may be digitized.

At operation 620, the received human language input may be understood and parsed to identify a segment corresponding to a story. In implementations, the identified story segment may include a plot narrative, character expansion/creation, and/or or setting expansion/creation. For example, as discussed above with reference to NLU component 310 and NLP story parser component 320, the input may be parsed to identify/classify keywords such as character names, setting names, and/or actions corresponding to a story. In implementations where the received human language input is verbal input, operation 620 may include converting digitized speech to text.

At operation 630, the identified story segment received from the user may be used to a update a story record. For example, a story record 305 stored in a storage 260 may be updated. The story record may comprise a chronological record of all story segments relating to a collaborative story developed between the user and the AI. The story record may be updated as discussed above with reference to story record component 330.

At operation 640, using at least the identified story segment and/or the present story record, an AI story segment may be generated. In addition, the generated story segment may be used to update the story record. Any one of the methods discussed above with reference to story generator component 340 may be implemented to generate an AI story segment. For example, story generator component 340 may implement a beam search-and-rank algorithm as discussed above with reference to FIGS. 3-4. As another example, the AI story segment may be generated by implementing a sequence-to-sequence style language dialogue generation system as discussed above with reference to FIG. 5. As a further example, the AI story segment may be generated using a multipart system as discussed above with reference to FIG. 8. For example, the multipart system may include: i) a classifier or decision component to decide whether the “next suggested segment” should be plot narrative, character expansion, or setting expansion; and ii) a generation system for each one of those segment types.

At operation 650, the AI-generated story segment may be transformed into natural language to be presented to the user. A NLG component 350, as discussed above, may be used to perform this operation. At operation 660, the natural language may be presented to the user. For example, the natural language may be displayed as text on a display or output as speech using a speaker. In implementations where the natural language is output as speech, a speech synthesis component 360 as discussed above may be used to be to transform the machine-generated natural language into auditory speech.

In some implementations, the story-writing may be accompanied by automated audio and visual representations of the story as it is being developed. For example, in a VR or AR system, as each agent—human, and AI—suggest a story segment, the story segment may be represented in an audiovisual VR or AR representation around the human participant (e.g., during operation 660). For example, if a story segment is “and then the princess galloped off to save the prince,” there may appear a representation of a young woman with a crown on horseback, galloping across the visual field of the user. Text-to-video and text-to-animation components may be utilized at this phase for visual story rendering. For example, animation of an AI character may be performed in accordance with Daniel Holden et al., Phase-Functioned Neural Networks for Character Control, 2017, which is incorporated herein by reference.

In AR/VR implementations, any presented VR/AR objects (e.g., characters) may adapt to the environment of the user collaborating with the AI for storytelling. For example, a generated AR character may adapt to conditions where storytelling is taking place (e.g., temperature, location, etc.), a time of day (e.g., daytime versus nighttime), a time of year (e.g., season), environmental conditions, etc.

In some implementations, the generated AI story segments may be based, at least in part, on detected environmental conditions. For example, temperature (e.g., as measured in the user's vicinity), time of day (e.g., daytime or nighttime), time of year (e.g., season), the date (e.g., current day of the week, current month, and/or current year), weather conditions (e.g., outside temperature, whether it is rainy or sunny, humidity, cloudiness, fogginess, etc.), location (e.g., location of user collaborating with the AI storytelling agent, whether the location is inside or outside a building, etc.), or other conditions may be sensed or otherwise retrieved (e.g., via geolocation), and incorporated into generated AI story segments. For example, given known nighttime and rainy weather conditions, an AI Character may begin a story with “It was on a night very much like this . . . ” In some implementations, environmental conditions may be detected by a storytelling device 200. For example, a storytelling device 200 may include a temperature sensor, a positioning component (e.g., global positioning receiver), a cellular receiver, or a network interface to retrieve (e.g., over a network connection) or measure environmental conditions that may be incorporated into generated AI story segments.

In some implementations, data provided by the user may also be incorporated into generated story segments. For example, a user may provide birthday information, information regarding the user's preferences (e.g., favorite food, favorite location, etc.), or other information that may be incorporated into story segments by the collaborative AI storytelling agent.

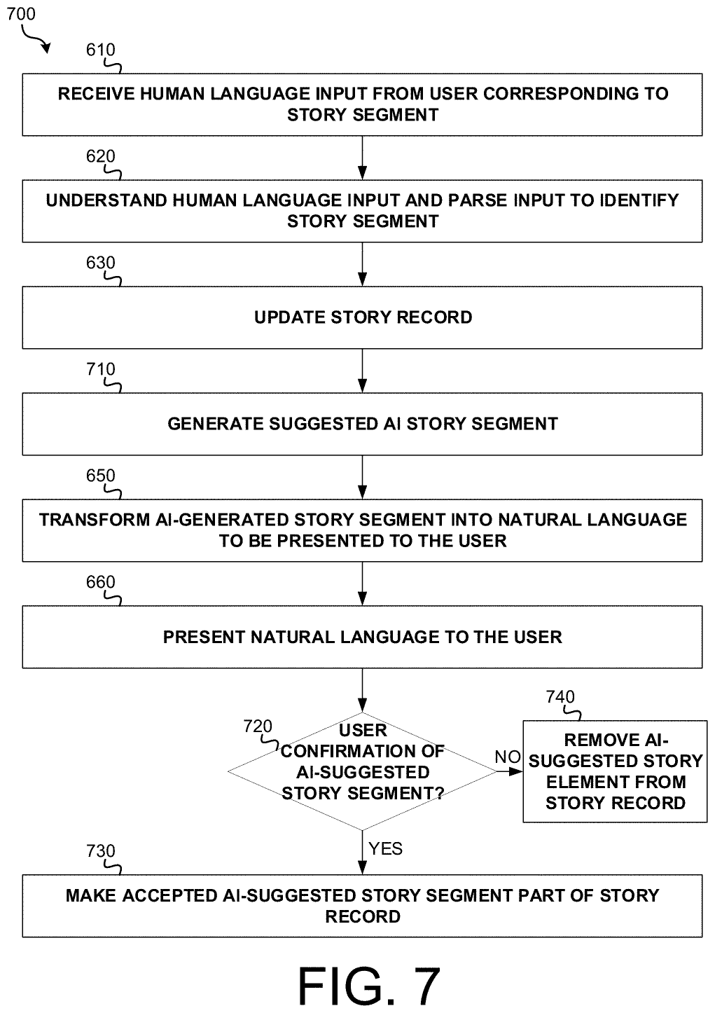

In some implementations, a confirmation loop may be included in the collaborative AI storytelling such that story segments generated by story generation software 300 (e.g., story step generated by story generator component 340) are suggested story segments that the user may or may not approve. By way of example, FIG. 7 is an operational flow diagram illustrating an example method 700 of implementing collaborative AI storytelling with this confirmation loop in accordance with the disclosure. In implementations, method 700 may be performed by executing story generation software 300 or other machine readable instructions stored in a device 200.

As illustrated, method 700 may implement operations 610-630 as discussed above with reference to method 600. After identifying a story segment from the human input and updating the story record, at operation 710 a suggested AI story segment is generated. In this case, the suggested story segment may be stored in the story record as a “soft copy” or temporary file line. Alternatively, the suggested story segment may be stored separately from the story record. After generating the suggested AI story segment, operations 650-660 may be implemented as discussed above to present natural language corresponding to the suggested story element to the user.

Thereafter, at decision 720, it may be determined whether the user confirmed the AI-suggested story segment. For example, the user may confirm the AI-suggested story segment by responding with an additional story segment that builds upon the AI-suggested story segment. If the segment is confirmed, at operation 730, the AI-suggested story segment may be made part of the story record. For example, the story segment may be converted from a temporary file to a permanent part of the story record, and may thereafter be considered as part of the story segment inputs for future story generation.

Alternatively, at decision 720, it may be determined that the user rejected, countered, and/or did not respond to the AI-suggested story segment. In such cases, the AI-suggested story element may be removed from the story record (operation 740). In cases where the story element is a separate, temporary file from the story record, the temporary file may be deleted.

In AR/VR implementations where a story segment is countered or rewritten, the AR/VR representation may adapt. For example, if the story segment contained a correction or expansion, such as: “But she wasn't wearing her crown, she had it tucked away in her knapsack so as to go incognito,” then the animation may change and the young woman may gallop across the visual field on horseback, with a backpack and no crown on her head.

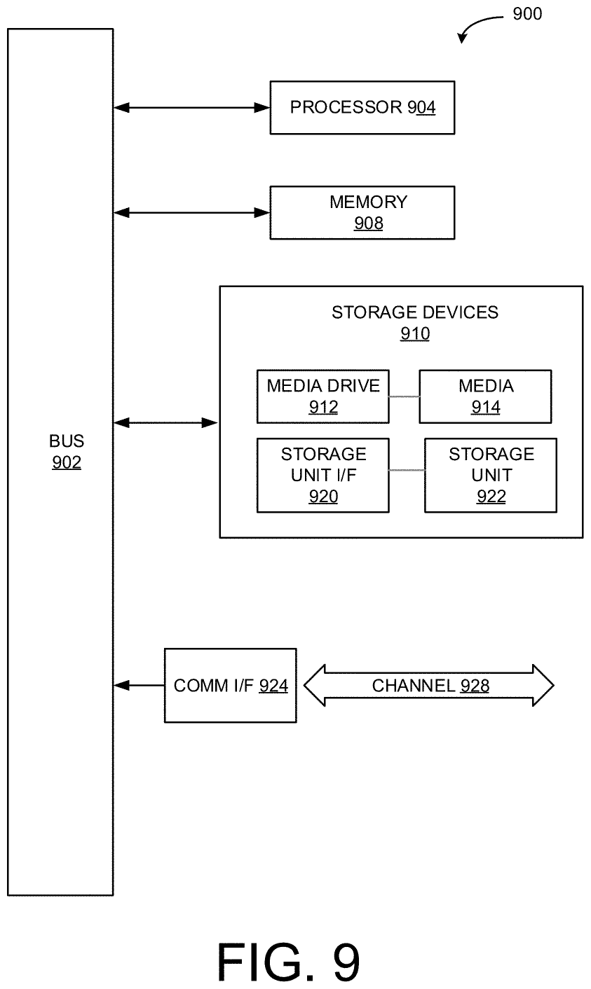

FIG. 9 illustrates an example computing component that may be used to implement various features of the methods disclosed herein.

As used herein, the term component might describe a given unit of functionality that can be performed in accordance with one or more implementations of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. In implementation, the various components described herein might be implemented as discrete components or the functions and features described can be shared in part or in total among one or more components. In other words, as would be apparent to one of ordinary skill in the art after reading this description, the various features and functionality described herein may be implemented in any given application and can be implemented in one or more separate or shared components in various combinations and permutations. Even though various features or elements of functionality may be individually described or claimed as separate components, one of ordinary skill in the art will understand that these features and functionality can be shared among one or more common software and hardware elements, and such description shall not require or imply that separate hardware or software components are used to implement such features or functionality.

FIG. 9 illustrates an example computing component 900 that may be used to implement various features of the methods disclosed herein. Computing component 900 may represent, for example, computing or processing capabilities found within imaging devices; desktops and laptops; hand-held computing devices (tablets, smartphones, etc.); mainframes, supercomputers, workstations or servers; or any other type of special-purpose or general-purpose computing devices as may be desirable or appropriate for a given application or environment. Computing component 900 might also represent computing capabilities embedded within or otherwise available to a given device.

Computing component 900 might include, for example, one or more processors, controllers, control components, or other processing devices, such as a processor 904. Processor 904 might be implemented using a general-purpose or special-purpose processing engine such as, for example, a microprocessor, controller, or other control logic. In the illustrated example, processor 904 is connected to a bus 902, although any communication medium can be used to facilitate interaction with other components of computing component 900 or to communicate externally.

Computing component 900 might also include one or more memory components, simply referred to herein as main memory 908. For example, preferably random access memory (RAM) or other dynamic memory, might be used for storing information and instructions to be executed by processor 904. Main memory 908 might also be used for storing temporary variables or other intermediate information during execution of instructions to be executed by processor 904. Computing component 900 might likewise include a read only memory (“ROM”) or other static storage device coupled to bus 902 for storing static information and instructions for processor 904.

The computing component 900 might also include one or more various forms of information storage mechanism 910, which might include, for example, a media drive 912 and a storage unit interface 920. The media drive 912 might include a drive or other mechanism to support fixed or removable storage media 914. For example, a hard disk drive, a solid state drive, an optical disk drive, a CD, DVD, or BLU-RAY drive (R or RW), or other removable or fixed media drive might be provided. Accordingly, storage media 914 might include, for example, a hard disk, a solid state drive, cartridge, optical disk, a CD, a DVD, a BLU-RAY, or other fixed or removable medium that is read by, written to or accessed by media drive 912. As these examples illustrate, the storage media 914 can include a computer usable storage medium having stored therein computer software or data.

In alternative embodiments, information storage mechanism 910 might include other similar instrumentalities for allowing computer programs or other instructions or data to be loaded into computing component 900. Such instrumentalities might include, for example, a fixed or removable storage unit 922 and an interface 920. Examples of such storage units 922 and interfaces 920 can include a program cartridge and cartridge interface, a removable memory (for example, a flash memory or other removable memory component) and memory slot, a PCMCIA slot and card, and other fixed or removable storage units 922 and interfaces 920 that allow software and data to be transferred from the storage unit 922 to computing component 900.

Computing component 900 might also include a communications interface 924. Communications interface 924 might be used to allow software and data to be transferred between computing component 900 and external devices. Examples of communications interface 924 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 924 might typically be carried on signals, which can be electronic, electromagnetic (which includes optical) or other signals capable of being exchanged by a given communications interface 924. These signals might be provided to communications interface 924 via a channel 928. This channel 928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer readable medium”, “computer usable medium” and “computer program medium” are used to generally refer to non-transitory mediums, volatile or non-volatile, such as, for example, memory 908, storage unit 922, and media 914. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 900 to perform features or functions of the present application as discussed herein.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the application, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply at the functionality described or claimed as part of the component are all configured in a common package. Indeed, any or all of the various parts of a component, whether control logic or other parts, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent component names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

What is claimed is:

1. A non-transitory computer-readable medium having executable instructions stored thereon that, when executed by a processor, performs operations of:
receiving, from a user, human language input corresponding to a segment of a story;
understanding and parsing the received human language input to identify a first story segment corresponding to a story associated with a stored story record;
updating the stored story record using at least the identified first story segment corresponding to the story;
using at least the identified first story segment or updated story record, generating a second story segment;
transforming the second story segment into natural language to be presented to the user; and
presenting the natural language to the user.

2. The non-transitory computer-readable medium of claim 1, wherein receiving the human language input comprises: receiving vocal input at a microphone and digitizing the received vocal input; and wherein presenting the natural language to the user comprises:
transforming the natural language from text to speech; and
playing back the speech using at least a speaker.

3. The non-transitory computer-readable medium of claim 2, wherein understanding and parsing the received human language input comprises parsing the received human language input into one or more token segments, the one or more token segments corresponding to a character, setting, or plot of the story record.

4. The non-transitory computer-readable medium of claim 2, wherein generating the second story segment comprises:
performing a search for a story segment within a database comprising a plurality of annotated story segments;
scoring each of the plurality of annotated story segments searched in the database; and
selecting the highest scored story segment as the second story segment.

5. The non-transitory computer-readable medium of claim 2, wherein generating the second story segment comprises: implementing a sequence-to-sequence style language dialogue generation model that has been pre-trained on narratives of a desired type to construct the second story segment, given the updated story record as an input.

6. The non-transitory computer-readable medium of claim 2, wherein generating the second story segment comprises:
using a classification tree to classify whether the second story segment corresponds to a plot narrative, a character expansion, or setting expansion; and
based on the classification, using a plot generator, a character generator, or setting generator to generate the second story segment.

7. The non-transitory computer-readable medium of claim 2, wherein the generated second story segment is a suggested story segment, wherein the instructions, when executed by the processor, further perform operations of:
temporarily storing the suggested story segment;
determining if the user confirmed the suggested story segment; and
if the user confirmed the suggested story segment, updating the stored story record with the suggested story segment.

8. The non-transitory computer-readable medium of claim 7, wherein the instructions, when executed by the processor, further perform an operation of: if the user does not confirm the suggested story segment, removing the suggested story segment from the story record.

9. The non-transitory computer-readable medium of claim 1, wherein receiving the human language input comprises: receiving textual input at a device; and wherein presenting the natural language to the user comprises: presenting text to the user.

10. The non-transitory computer-readable medium of claim 2, wherein the generated second story segment incorporates a detected environmental condition, the detected environmental condition comprising: a temperature, a time of day, a time of year, a date, a weather condition, or a location.

11. The non-transitory computer-readable medium of claim 10, wherein presenting the natural language to the user comprises: displaying an augmented reality or virtual reality object corresponding to the natural language, wherein the display of the augmented reality or virtual reality object is based at least in part on the detected environmental condition.

12. A method, comprising:
receiving, from a user, human language input corresponding to a segment of a story;
understanding and parsing the received human language input to identify a first story segment corresponding to a story associated with a stored story record;
updating the stored story record using at least the identified first story segment corresponding to the story;
using at least the identified first story segment or updated story record, generating a second story segment;
transforming the second story segment into natural language to be presented to the user; and
presenting the natural language to the user.

13. The method of claim 12, wherein receiving the human language input comprises:
receiving vocal input at a microphone and digitizing the received vocal input; and
wherein presenting the natural language to the user comprises:
transforming the natural language from text to speech; and
playing back the speech using at least a speaker.

14. The method of claim 13, wherein understanding and parsing the received human language input comprises parsing the received human language input into one or more token segments, the one or more token segments corresponding to a character, setting, or plot of the story record.

15. The method of claim 13, wherein generating the second story segment comprises:
performing a search for a story segment within a database comprising a plurality of annotated story segments;
scoring each of the plurality of annotated story segments searched in the database; and
selecting the highest scored story segment as the second story segment.

16. The method of claim 13, wherein generating the second story segment comprises: implementing a sequence-to-sequence style language dialogue generation model that has been pre-trained on narratives of a desired type to construct the second story segment, given the updated story record as an input.

17. The method of claim 13, wherein generating the second story segment comprises:
using a classification tree to classify whether the second story segment corresponds to a plot narrative, a character expansion, or setting expansion; and
based on the classification, using a plot generator, a character generator, or setting generator to generate the second story segment.

18. The method of claim 13, wherein the generated second story segment is a suggested story segment, the method further comprising:
temporarily storing the suggested story segment;
determining if the user confirmed the suggested story segment; and
if the user confirmed the suggested story segment, updating the stored story record with the suggested story segment.

19. The method of claim 18, further comprising: if the user does not confirm the suggested story segment, removing the suggested story segment from the story record.

20. The method of claim 12, further comprising:
detecting an environmental condition, the detected environmental condition comprising: a temperature, a time of day, a time of year, a date, a weather condition, or a location, wherein the generated second story segment incorporates the detected environmental condition; and
displaying an augmented reality or virtual reality object corresponding to the natural language, wherein the display of the augmented reality or virtual reality object is based at least in part on the detected environmental condition.

21. A system, comprising:
a microphone;
a speaker;
a processor; and
a non-transitory computer-readable medium having executable instructions stored thereon that, when executed by the processor, performs operations of:
receiving at the microphone, from a user, human language input corresponding to a segment of a story;
understanding and parsing the received human language input to identify a first story segment corresponding to a story associated with a stored story record;
updating the stored story record using at least the identified first story segment corresponding to the story;
using at least the identified first story segment or updated story record, generating a second story segment;
transforming the second story segment into natural language to be presented to the user; and
presenting the natural language to the user using at least the speaker.
